(19) United States
(12) Patent Application Publication
(10) Pub. No.: US 2008/0318196 A1
(43) Pub. Date: Dec. 25, 2008

(54) DAL self service school library

(76) Inventors: Bachar Al Kabaz, Secaucus, NJ (US); Ussama Alkhabbaz, (US)

Correspondence Address: Bachar Al Kabaz / Ussama Al KHABBAZ, 770 5th St,, Secaucus, NJ, 07094, US

(21) Appl. No.: 11/985,280

(22) Filed: Feb. 25, 2008

Related U.S. Application Data
(60) Provisional application No. 60/930,969, filed on May 21, 2007.

(51) Int. Cl. G09B 5/00

(52) U.S. Cl. 434/317

(57) ABSTRACT

DAL education system, support education and teaching students in the third world. The DAL Education system is comprised of three systems/I, II, III/, to fit the request and the affordable schools need at the third word countries. The first DAL Education system/I/use kiosk self-service DAL e-library with DAL e-Book reader to be read throw domestic TV screen, the second DAL Education system/II/use, DAL Library keeper special software with DAL e-Book reader to be read throw domestic TV screen, the third DAL Education system/III/use, small cheap self-service DAL e-Magazine or monthly Author e-book library, with DAL e-Book reader to be read throw domestic TV screen. The DAL EDU. System made the e-book reading cheap easy and affordable to the third world students, this will support and increase the quality education to make the standard living third world people much better, as learning is the key to success in life.

### BACKGROUND OF THE INVENTION

1. Field of the Invention

The present invention relates an education system and more specifically to support an educational system and increase quality education standard to the third world students, and take care of the affordable cost to make the e-books reading possible and reachable, this education system will not make the students in the third world countries waiting years for cheap new e-books reading technology to come, until that technology time comes the DAL EDU. System can do the job by offering e-library and e-book reader with the minimum cost.

2. Background of the Prior Education System

As the e-books become available and cheap in this time, comparing with the paper books.

The e-book reading can be done by the pc, notebook, PDA. These e-book reading methods are expensive and the PDA is still not suitable for e-reading small screen high price, the price cost 1000$ to 300$, these price can not be afforded by the 90% of the third world students, that means they have to wait years until the e-reading technology becomes affordable to them. DAL Education System solve this problem by offering the e-library and the e-book reader with minimum cost as we can, the e-book reader can be 35$ in full color and large clear display. And by using DAL Education system makes e-reading possible to the poor students, the DAL Education systems are easy to use, easy to make e-books, e-magazines, no special tools are needed, we offer and explain how to use the DAL education system, no extra charge. Therefore, there is a strong need for an e-education system for a student in the third world. Such a system should be affordable to them and possible to apply and affordable for the students to use. Preferably, such a system should be relatively simple easy and inexpensive to manufacture.

### SUMMARY OF THE INVENTION

The present invention meets the aforementioned need in the third word countries for an education system that is provided in the minimum cost to be affordable. The present invention is designed to support and increase quality education for the poor countries schools and students. The education system of the present invention is simple easy and affordable to use, and is relatively simple and inexpensive to produce.

The present invention is divided into three systems/I,II,III/. The first system uses kiosk e-library self service with DAL e-book reader. The second system uses e-library keeper with special software for easy download e-books direct to the USB flash pen with DAL e-book reader, the third system uses small, inexpensive e-magazine library or e-book Author monthly library, with DAL e-book reader.

By offering DAL Education system the students at the third world countries can read e-books e-magazine Author monthly e-book without waiting years until new inexpensive e-book reader technology time comes.

### BRIEF DESCRIPTION OF THE DRAWINGS

FIG. 1 is DAL Education system/I/a kiosk e-library self service of the present invention.

FIG. 2 is a perspective Block diagram of the first DAL Education system/I/of the present invention.

FIG. 3 is s a perspective schematic Block diagram of the first DAL Education system/I/reading color e-books, e-magazines by DAL EDU.TV e-book reader of the present invention.

FIG. 4 shows the first DAL Education system/I/of the present invention.

FIG. 5 shows the first DAL Education system/I/of the present invention.

FIG. 6 shows the second DAL Education system/II/of the present invention.

FIG. 7 shows the second DAL Education system/II/of the present invention.

FIG. 8 shows the third DAL Education system e-magazine library/III/no computer for e-library neither e-magazine reader of the present invention.

FIG. 9 shows the third DAL Education system e-magazine library/III/no computer for e-library neither e-magazine reader of the present invention.

FIG. 10 shows the DAL Education e-book reader/Model 3/in full color large display of the present invention.

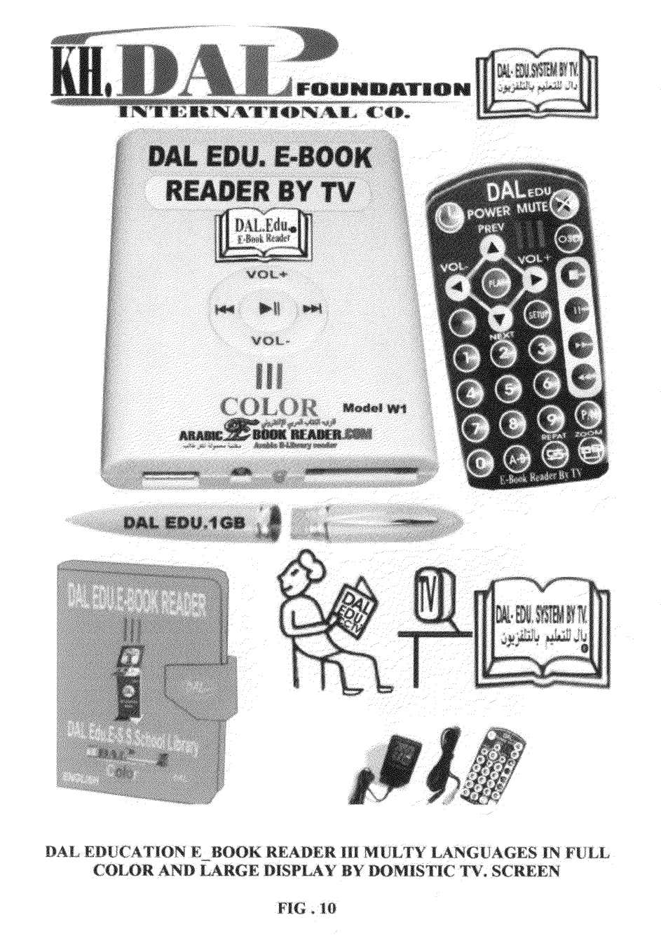

### DETAILED DESCRIPTION OF THE PREFERRED EMBODIMENT

The education system of the present invention has three systems with

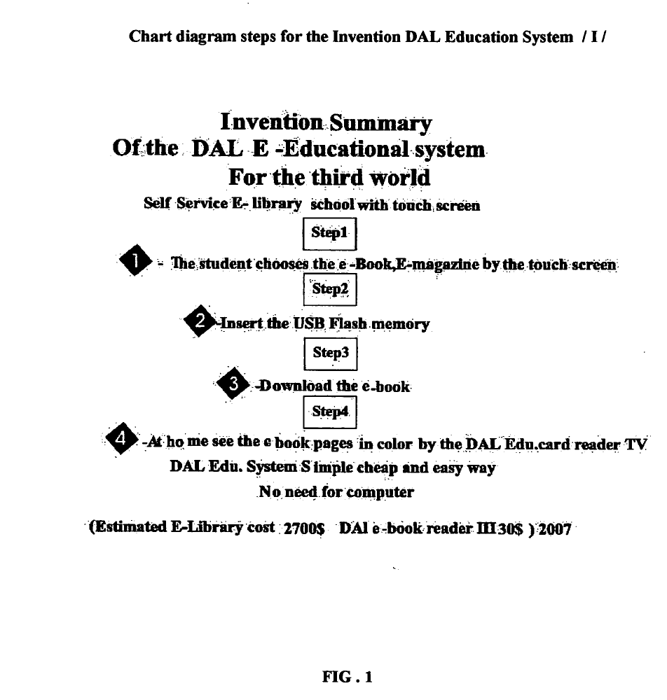

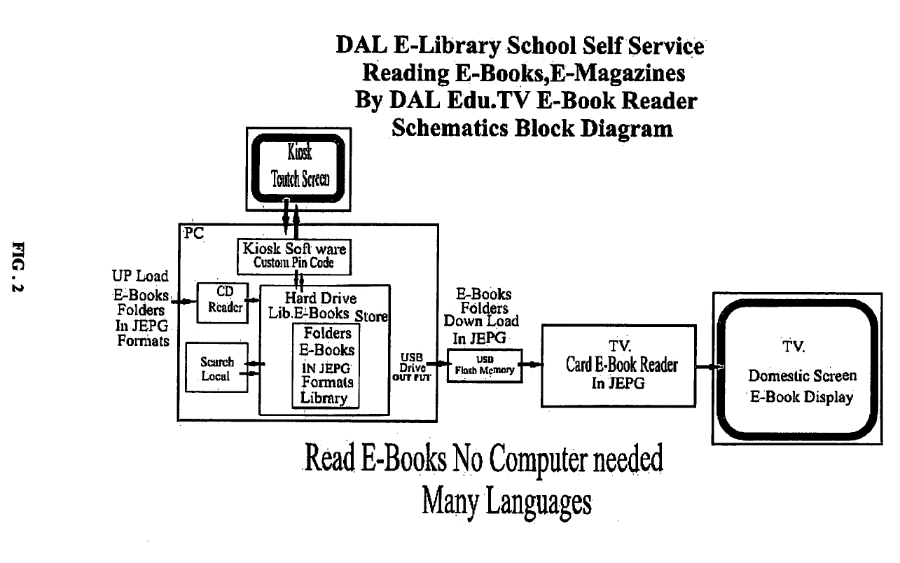

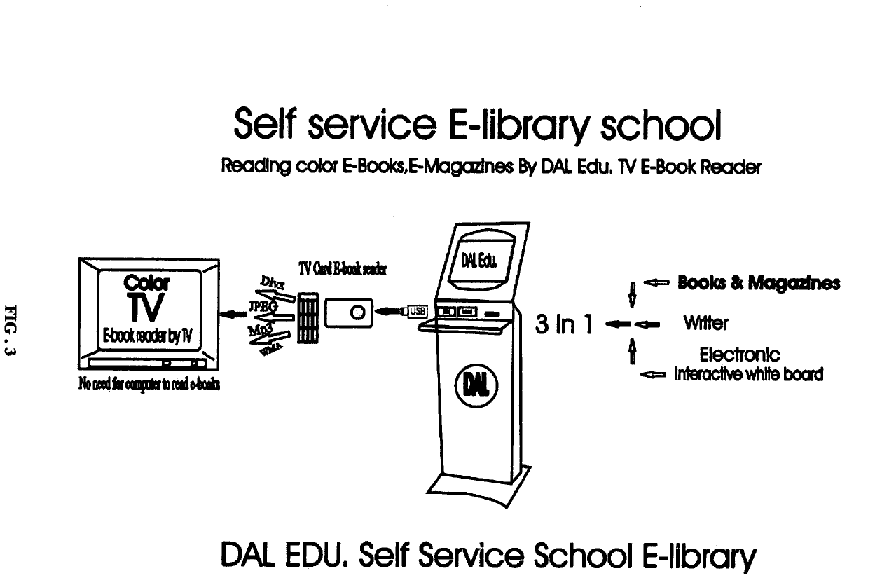

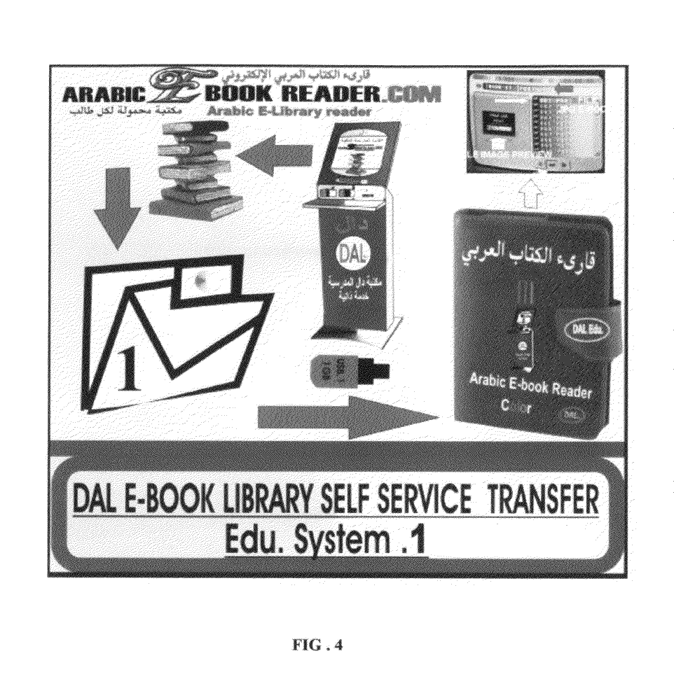

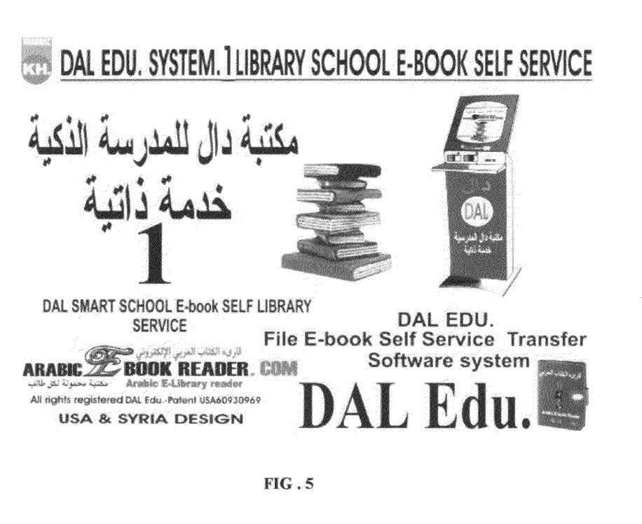

The first education system comprising a kiosk e-library self service, can have size up to 25000 e-books at one time/depends on the size HDD/, student download e-books to the USB flash memory pen size 1 GB, the USB flash pen comes with the DAL EDU. e-book reader model 3, student browse the touch screen by finger touch chose the e-book read summary e-book, one touch to download e-book, after insert USB flash pen, after download completed student read the e-book at home by the DAL EDU. E-book reader throw domestic TV. screen in full color and large reading, the e-library can be with friction charge or free of charge as in public library service. As seen in FIG. 1, FIG. 2, FIG. 3, FIG. 4, FIG. 5, Page 8, Page 9, Page 10, Page 11, Page 12.

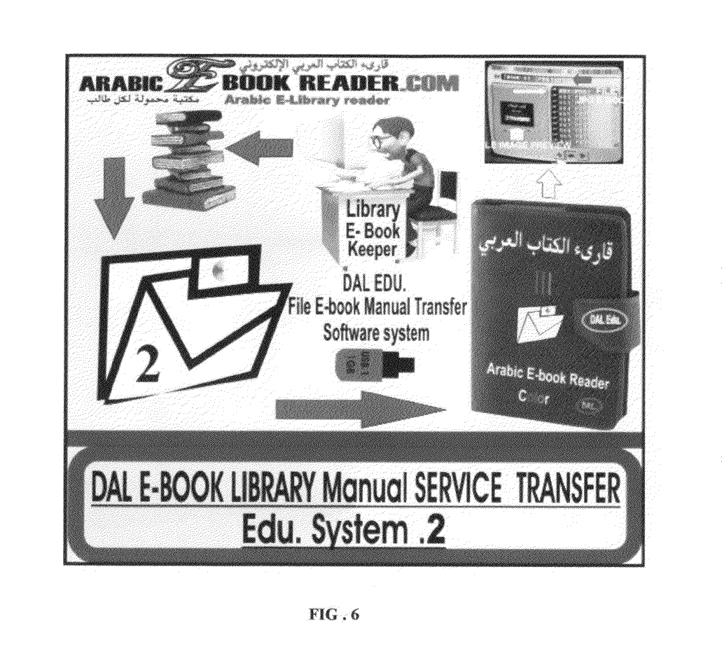

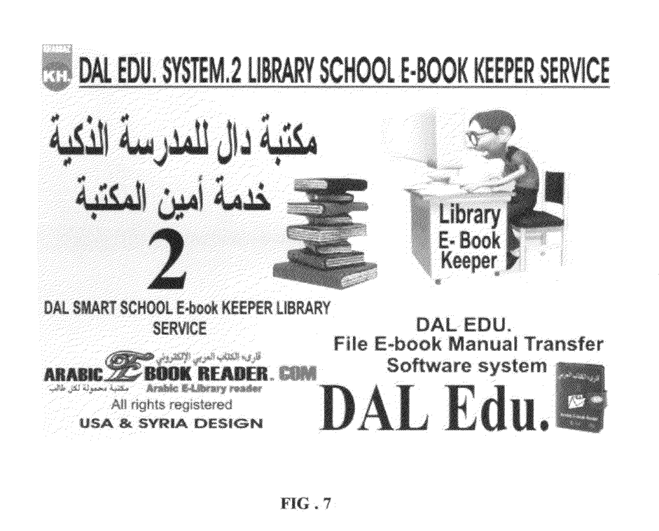

The second education system comprising is DAL Education system/I/this system uses, DAL Library keeper special software, this software is cheap and available in the market/makes easy to download e-books, direct to the USB flash memory attached to the DAL e-book reader/with DAL e-Book reader to be read throw domestic TV screen, in full color and large display with minimum cost, and in this system we do not have to charge the schools for the kiosk self service DAL e-library, if they already have their own PCs, as some schools have their own pc in the ordinary books library, they pay for the software cost only, which cost around 35$, to allow students read e-books according to their standard living. As seen in FIG. 6, FIG. 7 Page 13 and Page 14.

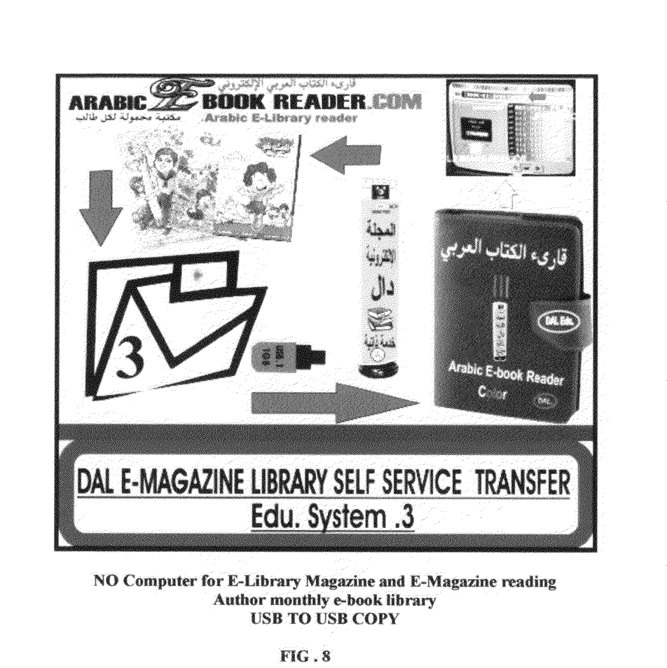

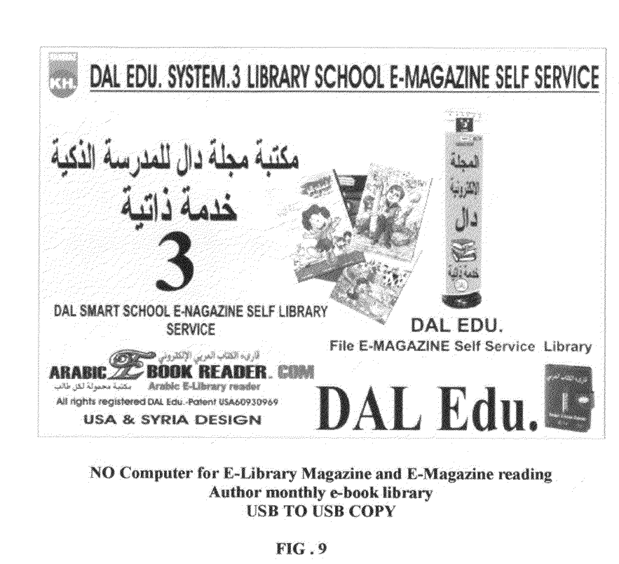

The third education system comprising is DAL Education system/III/this system uses, small, cheapest self-service DAL e-Magazine or monthly Author e-book library, with DAL e-Book reader, to be read throw domestic TV screen. In full color and large clear display with the minimum cost, to allow students read e-books e-magazine according to their standard living this DAL e-magazine library simple easy to use, student insert USB flash pen, insert small coin if is not free, pres one button download e-Magazine, wait maximum 5 minutes to download e-magazine 200 pages full color, when the power switch off automatically student can remove the USB pen, at home read the e-magazine throw domestic TV. Screen large clear reading beautiful and attractive color. As seen in FIG. 8, FIG. 9 Page 15 and Page 16. The DAL Education system use JPEG Format. Results of evaluation the main program to do the changing to JPEG in batch, Microsoft Power Point is the best to change the format to JPEG, The set up page Font minimum size 28, Normal Font size 32, page width 25 cm. page Height 19 cm, margin free all around frame 1 cm. the program give us the best clear images we can get, the results clear JPEG images beautiful color, the program available all over the world in multi languages for some application e-books with large size pages more than 1000 pages, we need to optimize the JPEG images, We use program call optimizer 7 available free. The software for DAL Education system/II/, we use/Smart File Copy program/to do the job, the program is available with reasonable price, the library keeper can use it in multi languages, easy to keep e-books, simple to download directly to the USB port.

Size page at DAL Education system equal half size page in normal paper page DIN A4 size.

I hope with my new invention as an American citizen succeeded to help the poor student in the third world to get better quality education with the affordable cost.

I claim:

1. An education system comprising:
Three education systems, DAL EDU. SYSTEM/, I, II, III/
To support and increase the quality education and fit the request, need, and affordable to the third world schools e-libraries and students.
1—DAL EDU.SYSTEM/I/:
The first DAL Education system/I/, this system uses, kiosk self-service DAL e-library with DAL e-Book reader to be read throw domestic TV screen, in full color and large clear display.
With the minimum cost, to allow students read e-books according to their standard living.
2—DAL EDU.SYSTEM/II/:
The second DAL Education system/II/this system uses, DAL Library keeper special software/makes easy to download e-books, direct to the USB flash memory attached to the DAL e-book reader/with DAL e-Book reader to be read throw domestic TV screen, in full color and large clear display with minimum cost, and in this system we do not charge the schools for the kiosk self service DAL e-library, if they already have their own PCs, they pay for the software only, which cost 35$, to allow students read e-books according to their standard living.
3—DAL EDU. SYSTEM/III/:
The third DAL Education system/m/uses, small, cheapest self-service DAL e-Magazine or monthly Author e-book library, with DAL e-Book reader, to be read throw domestic TV screen. In full color and large clear display with the minimum cost, to allow students read e-books e-magazine according to their standard living.
